(19) United States
(12) Patent Application Publication
(10) Pub. No.: US 2023/0027928 A1
(43) Pub. Date: Jan. 26, 2023

(54) THERMOPLASTIC ELASTOMER COMPOSITION HAVING LOW DENSITY AND GOOD MECHANICAL PROPERTIES BY USING UNCOATED HOLLOW GLASS SPHERES

(71) Applicant: KRAIBURG TPE GmbH & Co. KG, Waldkraiburg (DE)

(72) Inventors: Martina Hetterich, Haar (DE); Frieder Vielsack, Waldkraiburg (DE)

(21) Appl. No.: 17/440,547

(22) PCT Filed: Mar. 13, 2020
(86) PCT No.: PCT/DE2020/100190

§ 371 Date: Feb. 18, 2022

(30) Foreign Application Priority Data
Mar. 22, 2019 (DE) 10 2019 107 468.1

(51) Int. Cl. C08L 53/00

(52) U.S. Cl. CPC C08L 53/00

(57) ABSTRACT

A thermoplastic elastomer composition contains a styrene block copolymer (SBC), a polyolefin or copolyester-based thermoplastic elastomer and uncoated hollow glass spheres, wherein the polyolefin or thermoplastic elastomer is functionalized by a grafting reaction with a vinyl alkoxysilane, a vinyl acyloxysilane, a methacryloxyalkyl alkoxysilane or a methacryloxyalkyl acyloxysilane or with an anhydride of an unsaturated organic acid. A method for producing a thermoplastic elastomer using the thermoplastic elastomer composition, and the thermoplastic elastomer obtained in the process are also disclosed. Furthermore, various uses of the thermoplastic elastomer, in which a thermoplastic elastomer having low density and yet good mechanical properties is required, are disclosed.

The present invention relates to a thermoplastic elastomer composition which contains a styrene block copolymer (SBC), a polyolefin or a copolyester-based thermoplastic elastomer (TPC) and uncoated hollow glass spheres, wherein the polyolefin or TPC is functionalized by a grafting reaction with a vinyl alkoxysilane, a vinyl acyloxysilane, a methacryloxyalkyl alkoxysilane, a methacryloxyalkyl acyloxysilane or with an anhydride of an unsaturated organic acid. The present invention also relates to a method for producing a thermoplastic elastomer using the thermoplastic elastomer composition according to the invention, and to the thermoplastic elastomer obtained in the process. Furthermore, the invention also relates to various uses of the thermoplastic elastomer, in which a thermoplastic elastomer having low density and yet good mechanical properties is required.

Thermoplastic elastomers are required in many applications or for producing various components. A weight reduction is often desired here, with the result that the thermoplastic elastomers used are to have a low density. However, the lowering of the density of thermoplastic elastomers is not to be to the detriment of the mechanical properties and processability. In addition, it is desired that no foaming processes are necessary to produce a low-density thermoplastic elastomer, and that they are processable using standard injection-moulding processes or standard extrusion processes.

Vinyl alkoxysilanes, vinyl acyloxysilanes, methacryloxyalkyl acyloxysilanes and methacryloxyalkyl alkoxysilanes are known to be suitable for the free-radical grafting of polyolefins. These so-called organofunctional silanes are suitable for the surface modification of mineral and metallic surfaces, since almost all of these surfaces have hydroxyl groups which generally form covalent bonds with alkoxysilanes (Si-OR+HO-Y—>Si—O-Y+HO-R) and thus allow bonding between surface and silane. Since the surface of hollow glass spheres is covered with Si—OH groups, which can react with alkoxysilanes or acyloxysilanes, alkoxysilanes and acyloxysilanes are eminently suitable for binding hollow glass spheres to polymers.

Up to now, production methods have been known here in which non-functionalized glass spheres are bound to the elastomeric phase of a thermoplastic elastomer via a functionalized elastomer. This is effected by using grafted SBC instead of grafted polypropylene. However, the thermoplastic elastomers obtained often do not have sufficiently good mechanical values.

To lower the density of pure thermoplastic compositions, which do not contain any elastomers, production methods are known in which a functional group is first applied to the surface of hollow glass spheres, to which functional group a thermoplastic is coupled in an emulsion process. The hollow glass spheres which were first functionalized and coated with thermoplastic by the emulsion process then have to be dried and isolated before they can be embedded in additional thermoplastic, for which a lowering of the density is desired. This multi-step method is not only complex in terms of process engineering, but also time-consuming and cost-intensive. Furthermore, methods for lowering the density of thermoplastic cannot be readily transferred to thermoplastic elastomers, since the latter consist of at least two phases.

Furthermore, the same applicants as for the present invention have already filed a patent application for an invention, namely the as yet unpublished application with the application number DE 10 2017 122 314, in which a thermoplastic elastomer composition having low density and good mechanical properties is disclosed, which contains a styrene block copolymer (SBC), a polyolefin, which is functionalized with an anhydride of an organic acid, and hollow glass spheres, which are surface-treated or surface-coated with a silane-based agent. Here, the applicants always assumed that the surface coating of the hollow glass spheres is necessary for binding the hollow glass spheres to the thermoplastic phase in order to be able to provide a thermoplastic elastomer (TPE) that is both light and has good mechanical values.

That is to say, comparative tests using a functionalized SBC instead of the functionalized polyolefin led to a weight reduction of the TPE obtained, but with unsatisfactory values. It was therefore assumed that it is necessary to ensure that the hollow glass spheres are bound to the polyolefin used. For this purpose, surface-coated hollow glass spheres and a functionalized polyolefin, via which mutual binding can take place, were used in the precursor patent application.

Surprisingly, the inventors of the present application have now found that lightweight thermoplastic elastomers with comparable mechanical properties can also be produced without the use of surface-treated or surface-coated hollow glass spheres if the polyolefin or the TPC is still present as a functionalized polyolefin or functionalized TPC.

The present invention achieves the object of providing a thermoplastic elastomer or an alternative composition which has a low density (preferably <0.9 g/cm³), and in which the mechanical values lie in a range which makes it suitable for a variety of desired applications.

In addition, the thermoplastic elastomers can be produced more easily, more cost-effectively and more rapidly than if previously surface-coated hollow glass spheres are used.

The thermoplastic elastomer composition according to the invention contains a styrene block copolymer (SBC), a polyolefin or a copolyester-based thermoplastic elastomer and uncoated hollow glass spheres, wherein the polyolefin or copolyester-based thermoplastic elastomer is functionalized by a grafting reaction with a vinyl alkoxysilane, a vinyl acyloxysilane, a methacryloxyalkyl alkoxysilane, a methacryloxyalkyl acyloxysilane or with an anhydride of an organic acid (functionalized polyolefin or TPC). The thermoplastic elastomer composition according to the invention can be processed as a simple mixture of its components to form a thermoplastic elastomer e.g. in an extruder. No complex intermediate steps or isolations of intermediate products are necessary for this.

According to the present application, by a thermoplastic elastomer is meant one that consists of a polymer blend which comprises an elastomer and a thermoplastic or thermoplastic elastomer and, at its service temperature, has properties similar to those of vulcanized rubber, but which can be processed and reprocessed at elevated temperatures like a thermoplastic.

Since the thermoplastic elastomer compositions according to the invention contain a styrene block copolymer (SBC) as elastomeric component, they are also referred to here as styrene block copolymer-based thermoplastic elastomer compositions (TPS). The same also applies to the thermoplastic elastomers according to the invention.

It is assumed that, because of their constituents, the thermoplastic elastomers produced from the thermoplastic composition according to the invention have a thermoplastic phase and an elastomeric phase, wherein the elastomeric phase comprises the SBC and the thermoplastic phase comprises the functionalized polyolefin or the functionalized TPC. It appears that the uncoated hollow glass spheres, like the coated hollow glass spheres of DE 10 2017 122 314, have an affinity with the thermoplastic phase and not with the elastomeric phase when a functionalized polyolefin or TPC is used. Comparative tests with functionalization of the elastomer instead of functionalization of the polyolefin or TPC yielded TPEs with much poorer mechanical properties.

The hollow glass spheres used for producing the thermoplastic elastomer according to the invention are uncoated, i.e. those which have no coating on their surface. In the present invention, by coating is meant a functionalizing step subsequently following the production of the hollow glass spheres. An uncoated hollow glass sphere is one the surface of which is formed of the glass of the hollow glass spheres.

In particular, the present invention also relates to an embodiment in which, in the thermoplastic elastomer composition according to the invention, the styrene block copolymer is a triblock copolymer in which the two terminal blocks are formed of polystyrene and the central block is formed of a polymer other than polystyrene. It is preferred here that the central block of the triblock copolymer is formed by a polyolefin. The styrene block copolymer is preferably one that is selected from the group consisting of SEBS, SEPS, SBS, SEEPS, SiBS, SIS, SIBS or a mixture thereof. Furthermore, it is preferred that the styrene block copolymer is not functionalized with an anhydride of an organic acid, a vinyl alkoxysilane, a vinyl acyloxysilane, a methacryloxyalkyl alkoxysilane or a methacryloxyalkyl acyloxysilane. The styrene block copolymer is more preferably one that is not grafted with an anhydride of an unsaturated organic acid, a vinyl alkoxysilane, a vinyl acyloxysilane, a methacryloxyalkyl alkoxysilane or a methacryloxyalkyl acyloxysilane. The styrene block copolymer is preferably not a grafted styrene block copolymer. The styrene block copolymer is preferably not a functionalized styrene block copolymer. The styrene block copolymer that can be used according to the invention will be described more precisely below.

In a further embodiment of the present invention, it is preferred that the functionalized polyolefin or TPC in the thermoplastic elastomer composition according to the invention is functionalized by an anhydride of an unsaturated organic dicarboxylic acid, preferably of an organic 1,2-dicarboxylic acid, or by a vinyl alkoxysilane, a vinyl acyloxysilane, a methacryloxyalkyl alkoxysilane or a methacryloxyalkyl acyloxysilane.

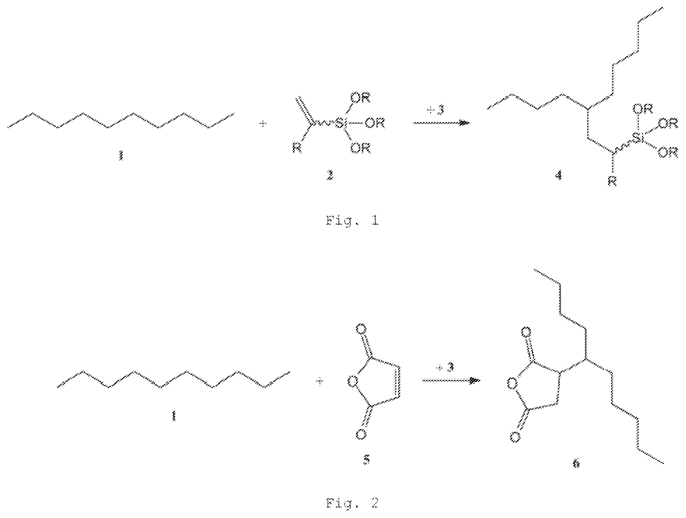

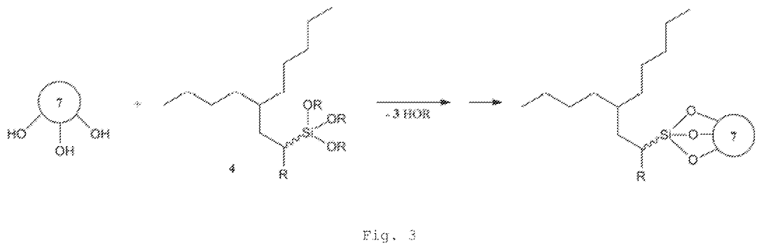

The anhydride of an unsaturated organic carboxylic acid or a vinyl alkoxysilane, a vinyl acyloxysilane, a methacryloxyalkyl alkoxysilane or a methacryloxyalkyl acyloxysilane is preferably bonded to the polyolefin or TPC by free-radical grafting. To this end, an anhydride of an unsaturated organic carboxylic acid or a vinyl alkoxysilane, a vinyl acyloxysilane, a methacryloxyalkyl alkoxysilane or a methacryloxyalkyl acyloxysilane is “grafted on” to a suitable polyolefin or TPC (grafting process). For this purpose, an anhydride of an unsaturated organic acid or a vinyl alkoxysilane, a vinyl acyloxysilane, a methacryloxyalkyl alkoxysilane or a methacryloxyalkyl acyloxysilane which has a reactive double bond is preferably used, for example maleic anhydride in the case of the anhydride, in the case of the organosilanes they are explicitly vinyl- or methacrylic acid-functionalized organosilanes. Further details of the polyolefin or TPC which is grafted with an anhydride of an unsaturated organic carboxylic acid or an alkoxy- or acyloxysilane, and of the production by a grafting reaction, will be described below and shown in FIGS. 1 and 2.

FIG. 1 shows the grafting reaction of a polyolefin or TPC 1 with a vinyl- or methacryloxysilane 2 in the presence of a radical initiator 3 to form a vinyl- or methacryloxysilane-grafted polyolefin or TPC 4.

Likewise, FIG. 2 shows the grafting reaction of a polyolefin or TPC 1 with maleic anhydride (MAH) 5 in the presence of a radical initiator 3 to form an MAH-grafted polyolefin or TPC 6.

FIG. 3 shows the binding of the hollow glass spheres 7 to the functionalized polyolefin or TPC 4 that was produced according to the equation in FIG. 1.

In a further embodiment of the present invention, the functionalized polyolefin in the thermoplastic composition according to the invention is preferably a functionalized polypropylene. Quite particularly preferably, the functionalized polyolefin is a maleic anhydride-grafted polypropylene (MAH-g-PP).

In a further embodiment of the present invention, the thermoplastic elastomer composition can additionally contain a polyolefin or TPC which is preferably not functionalized with an anhydride of an organic carboxylic acid (non-functionalized polyolefin or TPC). Particularly preferably, the non-functionalized polyolefin is polypropylene or polyethylene, more preferably polypropylene. Polyolefins that can be used according to the invention will be described below. It is also preferred that the non-functionalized polyolefin is added to a composition according to the invention in which a functionalized polyolefin is used. Similarly, it is preferred that the non-functionalized TPC is used in a composition according to the invention in which a functionalized TPC is present.

In one embodiment, it is preferred that a polyolefin which is functionalized by a grafting reaction with an anhydride of an unsaturated organic acid is used in the composition according to the invention. In this embodiment, the resulting thermoplastic elastomer is suitable for adhesion to polypropylenes or polyamides.

In a further embodiment, it is preferred that a polyolefin which is functionalized by a grafting reaction with a vinyl alkoxysilane, a vinyl acyloxysilane, a methacryloxyalkyl alkoxysilane or a methacryloxyalkyl acyloxysilane is used in the composition according to the invention. In this embodiment, the resulting thermoplastic elastomer is suitable in particular for adhesion to polypropylenes. If adhesion to polyamides is desired, this can be achieved by the additional addition of a polyolefin which is functionalized by a grafting reaction with an anhydride of an unsaturated organic acid.

In a further embodiment, it is preferred that a TPC which is functionalized by a grafting reaction with a vinyl alkoxysilane, a vinyl acyloxysilane, a methacryloxyalkyl alkoxysilane or a methacryloxyalkyl acyloxysilane, or with an anhydride of an unsaturated organic acid, preferably with an anhydride of an unsaturated organic acid and still more preferably maleic anhydride, is used in the composition according to the invention. In this embodiment, the resulting thermoplastic elastomer is preferably used for adhesion to polar thermoplastics, such as e.g. ABS, PC, PC/ABS, PA or SAN.

The thermoplastic elastomer composition can also additionally contain a plasticizer. Corresponding plasticizers that can be used according to the invention will likewise be described below.

Furthermore, the thermoplastic elastomer composition according to the invention can also contain further additives, such as a stabilizer, an auxiliary material, a dye, a further filler that does not constitute hollow glass spheres, and/or a compatibilizer. These will likewise be described more precisely below.

The present invention also relates to a method for producing a styrene block copolymer-based thermoplastic elastomer. Here, the constituents of the thermoplastic elastomer composition according to the invention are mixed together at a temperature in the range of from 150° C. to 240° C., preferably in the range of from 180° C. to 220° C. The method according to the invention will be described in more detail below.

The present invention also relates to a thermoplastic elastomer which is obtainable or obtained using the method according to the invention. The thermoplastic elastomer according to the invention is characterized by a hardness in the range of from a Shore A hardness of 40 up to a Shore D hardness of 30, a low density in the range of from 0.5 to 1.1 g/cm³, a tensile strength of at least 2.0 MPa, an elongation at break of at least 100 k, and a compression set at room temperature after 72 hours of less than 70′. All of the named (preferred) features of the elastomer composition according to the invention are also to apply herein to the thermoplastic elastomer according to the invention.

The present invention also relates to the use of a polyolefin or TPC for producing a thermoplastic elastomer composition according to the invention or a thermoplastic elastomer according to the invention, wherein the polyolefin or TPC is functionalized by a grafting reaction with a vinyl alkoxysilane, a vinyl acyloxysilane, a methacryloxyalkyl alkoxysilane or a methacryloxyalkyl acyloxysilane, or an unsaturated anhydride of an organic carboxylic acid.

Furthermore, the present invention also relates to the use of uncoated hollow glass spheres for producing a thermoplastic elastomer composition according to the invention or a thermoplastic elastomer according to the invention.

It is known that thermoplastic elastomers are not only suitable as sole materials for producing possible products and articles. Rather, it is the particular characteristic of this class of materials that they form connections with thermoplastics (rigid plastics or rigid components), namely without the use of additional adhesives, adhesion promoters or adhesion-promoting methods, such as for example corona treatments. Furthermore, it is known that the composition of the respective TPE (flexible component) determines its ability and strength of the bond with the selected rigid component. The provision of TPEs having properties suitable for forming bonds with other thermoplastics is therefore almost always a task for TPE manufacturers.

The present invention therefore also relates to the use of a thermoplastic elastomer according to the invention for producing a composite material with a thermoplastic (rigid component), such as for example polyolefin, polyamide or a further polar thermoplastic, or for the adhesion of the thermoplastic elastomer composition according to the invention to one of these thermoplastics. In other words, the present invention also relates to a method for producing a composite material composed of the thermoplastic elastomer according to the invention and a thermoplastic, such as for example polyolefin, polyamide or a further polar thermoplastic, wherein the thermoplastic elastomer composition is joined to the thermoplastic. In the use according to the invention or the method according to the invention, injection moulding, multi-component injection moulding, insert injection moulding, extrusion, coextrusion or compression moulding is used as processing method for producing the articles, wherein injection moulding, multi-component injection moulding, insert injection moulding, extrusion and coextrusion are preferred and multi-component injection moulding is quite particularly preferred. As described above, the use of functionalized polyolefin is suitable in particular for adhesion to polypropylene or polyamide as the thermoplastic rigid component. As likewise described above, the use of functionalized TPC is suitable in particular for adhesion to polar thermoplastics.

The present invention thus also relates to a composite material composed of a thermoplastic elastomer according to the invention and a thermoplastic, particularly preferably a polyamide, polyolefin or a further polar thermoplastic, such as ABS, PC, PC/ABS or SAN.

The present invention also relates to the use of a thermoplastic elastomer according to the invention and/or the use of a composite material according to the invention as a component or shaped body in the automotive interior and exterior sector, industrial equipment, industrial tools, electrical tools for professional and/or private use, domestic appliances, products in the consumer electronics sector, medical consumables and devices, sports equipment, containers for toiletries and cosmetics, sealing materials or preparations of consumer products.

The components mentioned above and used in the thermoplastic elastomer compositions according to the invention or thermoplastic elastomers according to the invention and in the uses and methods according to the invention are described more precisely below:

A: styrene block copolymer

B: functionalized polyolefin or functionalized TPC

C: hollow glass spheres

D: polyolefin or TPC (non-functionalized in each case)

E: plasticizer

F: stabilizer, auxiliary material, colorant

Component A: Styrene Block Copolymer

By the term “styrene block copolymer” (SBC) is meant according to the invention a multiblock copolymer, wherein at least one of the blocks is polystyrene. At least one of the further blocks is usually a polybutadiene, polyisoprene or polyisobutene. The SBC can be a triblock copolymer of the structure A-B-A, wherein the A block is usually polystyrene and the B block is usually constructed from polybutadiene, polyisoprene or polyisobutene (SBS, SIS, SiBS). Alternatively, the styrene monomers in the A block can be partially or completely replaced by derivatives of styrene, such as for example α-methylstyrene, 2-methylstyrene, 3-methylstyrene, 4-methylstyrene, 4-tert-butylstyrene, 4-cyclohexylstyrene, or vinylnaphthalene, such as 1-vinylnaphthalene and 2-vinylnaphthalene. The B block can alternatively also contain mixtures of dienes, such as SIBS (B block composed of a mixture of butadiene and isoprene). Furthermore, SBCs consisting of styrene and diene monomers can also be used as hydrogenated derivatives. The units of the B blocks in this case are present partially or completely hydrogenated. Polystyrene-block-poly(ethylene-co-butylene)-block-polystyrene (SEBS), polystyrene-block-poly(ethylene-co-propylene)-block-polystyrene (SEPS) and polystyrene-block-poly(ethylene-co-(ethylene-propylene))-block-polystyrene (SEEPS) may preferably be mentioned here. Besides triblock copolymers, alternatively diblock, tetrablock or multiblock copolymers of the named monomers of styrene, styrene derivatives (A blocks) and butadiene, isoprene, isobutylene and mixtures thereof (B blocks) can also be used in different sequences of A and B blocks (for example B-A-B, A-B-A-B, etc.). Preferred SBCs are constructed from A-B-A triblock copolymers.

SBCs according to the invention preferably have a weight-average molecular weight (Mw) of from 50,000 to 1,000,000 g/mol, particularly preferably from 100,000 to 500,000 g/mol.

The SBC is present in the thermoplastic elastomer composition according to the invention or in the thermoplastic elastomer according to the invention preferably in a quantity in the range of from 12 wt.-% to 30 wt.-%, more preferably in the range of from 15 wt.-% to 25 wt.-% and most preferably in the range of from 18 wt.-% to 23 wt.-%, relative to the total weight of the thermoplastic elastomer composition or the thermoplastic elastomer.

Component B: functionalized polyolefin or functionalized TPC According to the invention, the polyolefin or TPC is functionalized with a vinyl alkoxysilane, a vinyl acyloxysilane, a methacryloxyalkyl alkoxysilane or a methacryloxyalkyl acyloxysilane, or an anhydride of an unsaturated organic acid, as described above. The functionalizing preferably takes place by means of grafting (grafting process), wherein a vinyl alkoxysilane, a vinyl acyloxysilane, a methacryloxyalkyl alkoxysilane or a methacryloxyalkyl acyloxysilane or an anhydride of an unsaturated organic acid is grafted on to a suitable polyolefin. After the grafting reaction with a vinyl alkoxysilane, the polyolefin or TPC is present as a 2-ethylalkoxysilane-modified polyolefin or TPC. After the grafting reaction with a vinyl acyloxysilane, the polyolefin or TPC is present as a 2-ethylacyloxysilane-modified polyolefin or TPC. After the grafting reaction with a methacryloxyalkyl alkoxysilane, the polyolefin or TPC is present as a 2-methylpropenoylalkylalkoxysilane-modified polyolefin or TPC. After the grafting reaction with a methacryloxyalkyl acyloxysilane, the polyolefin or TPC is present as a 2-methylpropenoylalkylacyloxysilane-modified polyolefin or TPC. After the grafting reaction with an anhydride of an unsaturated organic acid, the polyolefin or TPC is present as a 1,2-dicarboxylic-acid-modified polyolefin or TPC. These are the reaction products of the reaction of polyolefin or TPC with a vinyl alkoxysilane, a vinyl acyloxysilane, a methacryloxyalkyl alkoxysilane or a methacryloxyalkyl acyloxysilane or an anhydride of an unsaturated organic acid with the aid of radical initiators according to the reaction equations in FIGS. 1 and 2, which have already been described above.

By grafting is generally meant that in the case of already preformed molecular chains of a primary polymer (here the polyolefin or TPC) other molecular building blocks (here the vinyl alkoxysilane, vinyl acyloxysilane, methacryloxyalkyl alkoxysilane or methacryloxyalkyl acyloxysilane or the anhydride of the unsaturated organic carboxylic acid) are subsequently “grafted on” to them. Polymers which have been functionalized in such a way are also known as “graft polymers”. Graft polymers can be produced in various ways, e.g, after mixing of the primary polymer with the molecular building blocks to be grafted on in a desired ratio, and subsequent radical formation by decomposition of peroxides or by irradiation, preferably by peroxides. In the process, radical sites, to which the molecular building blocks to be grafted attach themselves, are formed on the primary polymer. For this purpose, the anhydride of the organic carboxylic acid must have a reactive site where the radical site of the primary polymer can engage.

Grafting can sometimes also occur if a mixture of primary polymer and molecular building blocks to be grafted on is subjected to intense thermomechanical treatment. The grafting reaction of polymers is preferably carried out in a solid-phase reactor, a roller mill, an extruder or in a reactor in solution or emulsion, and is known to a person skilled in the art in the field of thermoplastics. For polyolefin or TPC, the reaction in a solid-phase reactor or extruder is preferred.

By a polyolefin is meant in the present invention polymers which are produced by chain polymerization from alkenes, such as ethylene, propylene, 1-butene or isobutene. In the process, saturated polymers are preferably produced from the unsaturated alkenes by polymerization.

According to the invention, the polyolefins can be homopolymers, statistical copolymers, but also block copolymers, such as for example polyolefin block copolymers (OBC), wherein homopolymers or statistical copolymers which are preferably produced from alkenes, which are preferably aliphatic alkenes, are preferred according to the invention.

The polyolefins are particularly preferably non-elastomeric polyolefins, i.e. they do not have any elastomeric properties. More preferably, the polyolefins are thermoplastics.

Commercially available polyolefins, which are described below, can be used as base for the grafting:

Polyolefins can be for example homopolymers or statistical copolymers of olefins. Examples are: copolymers of polyethylene, such as HDPE (high-density polyethylene), MDPE (medium-density polyethylene), LDPE (low-density polyethylene), LLDPE (linear low-density polyethylene), VLDPE (very low-density polyethylene); a homopolymer of propylene (hPP); a statistical copolymer of propylene and ethylene (rPP); and combinations thereof.

Polyolefins that are suitable for the invention, as a base for functionalizing with the anhydride of a dicarboxylic acid, are primarily those that are suitable for processing by injection moulding. Suitable polyolefins are those with good flow properties and rigidity.

Homopolymers of propylene (hPP) are commercially available and any of these available hPPs can be used according to the invention. The use of hPP is preferred according to the invention.

Commercially available hPPs are, for example, products from LyondellBasell, which are available under the trade name Moplen®, such as Moplen® HP500N, Moplen® HP501L.

Statistical polypropylene copolymers (rPP) are likewise commercially available and any of these rPPs can be used according to the invention. Ethylene and/or butene is preferred as the comonomer.

Polyethylenes of various densities, such as HDPE, MDPE, LDPE, LLDPE, VLDPE, can be used according to the invention. These are sufficiently available commercially.

However, it is particularly preferred according to the invention that the polyolefin is one which comprises propylene in its repeating units. Still more preferably, the polyolefin is an hPP.

The OBCs which can be used according to the invention as polyolefins are block copolymers, the blocks of which are constructed from olefin monomers as repeating units. The OBCs according to the invention have at least two different polymer blocks. These blocks can be constructed from one type of olefin or two or more types of olefin. The olefins used to construct the OBCs that can be used according to the invention are aliphatic olefins, such as e.g. ethylene, propylene or butylene, wherein ethylene and propylene are preferred according to the invention. Particularly preferably, the OBCs which can be used according to the invention are constructed exclusively from aliphatic olefins as the so-called repeating units. According to the invention, the definition of OBCs excludes those which have an aromatic residue (these are known to a person skilled in the art as TPS (styrene-based thermoplastic elastomers)). Particularly preferred for the application described here or the composition according to the invention are OBCs the blocks of which are constructed from or consist of polypropylene, polyethylene or a statistical ethylene/propylene copolymer. OBCs of this type are commercially available under the trade name Hifax CA 10 A from LyondellBasell, for example. The polyolefin block copolymers described in detail in U.S. Pat. No. 8,481,637 B2 (referred to there as “olefin block copolymers, OBC”), to which reference is made here in full, are also particularly preferred. These are polymers which have alternating blocks of a hard (very rigid) and a soft (highly elastomeric) segment. Products of this type are sold by Dow Elastomers under the trade name INFUSE™. In particular, the grades recommended for use for TPE are preferred (INFUSE™ 9010, 9007, 9107, 9807).

Further examples of OBCs that can be used according to the invention are so-called hydrogenated diene block copolymers. Polymers of this type preferably have polymer blocks which consist of hydrogenated polybutadiene or hydrogenated polyisoprene.

It is preferred according to the invention that the OBCs are used together with a non-elastomeric polyolefin.

TPCs (copolyester-based TPEs) which are preferably suitable according to the invention are in general copolyesters in the form of copolymers which have monomer building blocks in the polymer main chain which are connected via ester groups (—C(═O)—O—). Thermoplastic copolyester elastomers of this type can be produced by polycondensation. Copolyesters of this type are preferably multiblock copolyesters, which usually have crystalline segments composed of hard blocks (X) and amorphous segments composed of soft blocks (Y). Suitable monomer components for constructing hard blocks (X) and soft blocks (Y) in multiblock copolyesters are known to a person skilled in the art. The copolyesters which are preferably used according to the invention have melting points or softening points in the range of from 160° C. to 300° C., preferably 165° C. to 270° C., particularly preferably 170° C. to 220° C. Preferred TPCs of the present invention are linear multiblock polyesters with a statistical distribution of high-melting-point, hard polyester blocks and low-melting-point, soft polyester blocks. The hard blocks here form crystalline regions and the soft blocks form amorphous regions, which bring about elastic behaviour at application temperatures of the TPCs. The hard polyester blocks are preferably constructed from short-chain dicarboxylic acids with fewer than 4 C atoms or aromatic dicarboxylic acids or mixtures of dicarboxylic acids. Aromatic dicarboxylic acids are preferred, and isophthalic acid or terephthalic acid is particularly preferred. The alcohol component is preferably likewise difunctional and consists of short-chain alkyl diols or short-chain polyoxyalkylene diols with fewer than 3 repeating units or mixtures of different diols. Short-chain diols, such as ethylene glycol, 1,3-propanediol, 1,4-butanediol, 1,4-cyclohexanedimethanol, are preferred, and 1,4-butanediol is particularly preferred. The soft polyester blocks preferably consist of aliphatic or aromatic dicarboxylic acids, preferably of aromatic dicarboxylic acids, quite particularly preferably of isophthalic acid or terephthalic acid. To produce soft regions in the TPCs, different types of diol are used: polyether diols, such as polyethylene glycols, polypropylene glycols, polyethylene-co-propylene glycols, polytetramethylene glycols or soft polyester diols constructed from alkanedicarboxylic acids, for example adipic acid or sebacic acid, and alkanediols, or polycaprolactone diols or aliphatic polycarbonate diols. However, mixtures of diols can also be used. Hard TPC regions, constructed from terephthalic acid and short-chain diols, particularly preferably 1,4-butanediol, combined with soft regions, preferably constructed from terephthalic acid and polyether diols, quite particularly preferably from polytetramethylene glycol, are preferred. The copolyesters which are suitable as component B in the compositions according to the invention can be produced using methods which are known to a person skilled in the art or they are commercially available. Suitable commercially available copolyesters are e.g. TICONA—Riteflex®, P.GROUP—PIBIFLEX®, DSM—Arnitel®, Kolon—KOPEL®, PTS—Uniflex®, Ria-Polymers—Riaflex®, LG Chem.—KEYFLEX®, and DuPont—Hytrel®.

If an anhydride of an unsaturated organic acid is used for the grafting reaction, maleic anhydride is particularly preferably used.

Where a vinyl alkoxysilane, a vinyl acyloxysilane, a methacryloxyalkyl alkoxysilane or a methacryloxyalkyl acyloxysilane is used for the grafting reaction, a mono-, di- or trialkoxy- or a mono-, di- or triacyloxysilane can be used, wherein a trialkoxysilane or triacyloxysilane are preferred. The alkoxy groups can furthermore be substituted or unsubstituted alkoxy groups. They are preferably C₁₋₈ alkoxy groups, wherein methoxy, ethoxy or propoxy groups are more preferred and methoxy groups are most preferred. The acyloxy groups can be C₁₋₈ acyloxy groups, wherein C₁₋₈ acyloxy groups are more preferred and the acetyloxy group is most preferred. The last-named groups preferably remain bound to the silicon atom of the silane after the grafting. In order that a silane can be grafted on, the alkoxysilane to be grafted on has a further group, which has a double bond or an epoxy group. This group can be, for example, a substituted or unsubstituted vinyl, epoxy or alkylacryloyl group (alkyl=C₁₋₅ alkyl, wherein C₁₋₃ alkyl is preferred and methyl is particularly preferred), which can also be bound to the silicon atom of the silane via one of the following groups —(CH₂)ₙ—O— or —(CH₂)ₙ—, wherein n=1 to 5, more preferably 1 to 3 and even more preferably is 3, wherein n-propyl is most preferred. In the case of the —(CHₙ)ₙ—O— group, the oxygen atom binds to the silicon atom of the silane. Such silanes to be grafted on are available for example under the trade name Geniosil® from Wacker.

Preferred vinylsilanes are: vinyltrialkoxysilanes (specifically vinyltrimethoxysilane, vinyltriethoxysilane), vinylalkyldialkoxysilanes (specifically vinyldimethoxymethylsilane), vinyltricarboxysilanes (specifically vinyltriacetoxysilane). These are shown in the following Formulae (I) to (III):

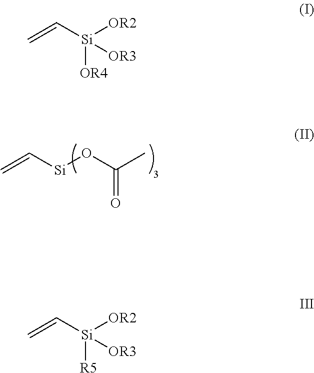

wherein R2 to R5, in each case independently of one another, are alkyl groups, preferably methyl or ethyl groups.

Preferred methacryloxyalkyl alkoxysilanes and methacryloxyalkyl acyloxysilanes are: 3-methacryloxypropyltrialkoxysilane or methacryloxymethyltrialkoxysilane (specifically 3-methacryloxypropyltrimethoxysilane, 3-methacryloxypropyl-triethoxysilane, methacryloxymethyltrimethoxysilane, methacryloxymethyltriethoxysilane), 3-methacryloxypropyl-alkyldialkoxysilane or methacryloxymethylalkyldialkoxysilane (specifically methacryloxymethyldimethoxymethylsilane), 3-methacryloxypropyltricarboxysilane or methacryloxymethyl-tricarboxysilane (specifically: 3-methacryloxypropyl-triacetoxysilane). These are shown in the following Formulae (IV) to (VI):

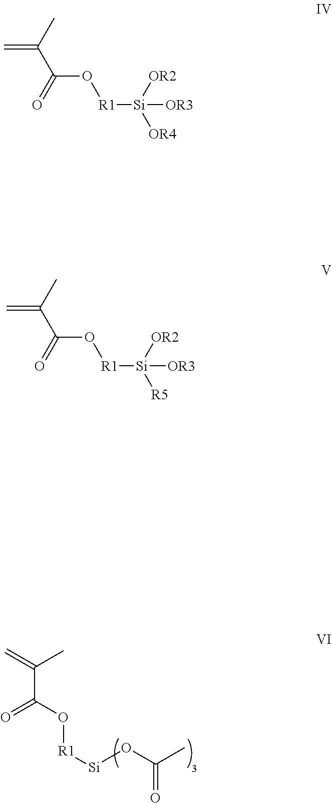

wherein R1 is an alkylene group, preferably a methylene or propylene group; and R2 to R5, in each case independently of one another, are alkyl groups, preferably methyl or ethyl groups.

The quantity of the anhydride of an unsaturated organic carboxylic acid in the grafted polyolefin lies in the range of from 0.1 wt.-% to 5 wt.-%, still more preferably in the range of from 0.5 wt.-% to 2 wt.-%, relative to the total weight of the polyolefin which is functionalized with an anhydride of an organic carboxylic acid.

The quantity of the vinyl alkoxysilane, vinyl acyloxysilane, methacryloxyalkyl alkoxysilane or methacryloxyalkyl acyloxysilane in the grafted polyolefin lies in the range of from 0.5 wt.-% to 5 wt.-%, still more preferably in the range of from 1 wt.-% to 4 wt.-%, relative to the total weight of the polyolefin which is functionalized with a vinyl alkoxysilane, a vinyl acyloxysilane, a methacryloxyalkyl alkoxysilane or a methacryloxyalkyl acyloxysilane.

According to the invention, polypropylene is preferably used as the polyolefin, particularly preferably hPP. A polypropylene grafted with maleic anhydride is also referred to among experts as MAH-g-PP. An MAH-g-PP of this type is known under the trade name “Scona® TPPP” and is available e.g, as the grades “Scona® TPPP 2112 GA” or “Scona® TPPP 8112 GA”.

The quantity of the anhydride of an unsaturated organic carboxylic acid in the grafted TPC lies in the range of from 0.1 wt.-% to 5 wt.-%, still more preferably in the range of from 0.5 wt.-% to 2 wt. %, relative to the total weight of the TPC which is functionalized with an anhydride of an organic carboxylic acid.

An MAH-g-TPC of this type is known under the trade name “Scona® TPHY” and is available e.g, as “Scona® TPHY 45602 PCX”.

In the thermoplastic elastomer composition according to the invention or the thermoplastic elastomer according to the invention, the weight ratio of functionalized polyolefin or TPC to SBC preferably lies in the range of from 15:100 to 140:100, more preferably in the range of from 20:100 to 98:100.

Component C: Hollow Glass Spheres

The hollow glass spheres that can be used for the thermoplastic elastomer composition according to the invention or the thermoplastic elastomer according to the invention have a glass shell and a hollow core, and can be filled with gas either at atmospheric pressure or under reduced pressure. The glass shell contains silicon dioxide as main component and can contain sodium oxide, magnesium oxide, calcium oxide, boron oxide, phosphorus oxide and the like as additional components.

The hollow glass spheres can be substantially round but can also deviate from this shape, e.g. can have the shape of an ellipse and/or have craters or indentations in the surface. It is preferred that the hollow glass spheres have a ratio of shortest axis to longest axis of 0.85, more preferably 0.90 and most preferably 0.95.

Since high shear forces are at work during the mixing of the thermoplastic elastomer composition according to the invention, hollow glass spheres can break. It is necessary to avoid this breakage by correctly selecting the isostatic collapse strength. The hollow glass spheres preferably have an isostatic collapse strength (10 vol.-%) of 55 MPa or above, more preferably 69 MPa or above and most preferably 100 MPa or above. The “isostatic collapse strength (13 vol.-%)” is defined according to ASTM D-3102-78, wherein an appropriate quantity of the hollow glass spheres is introduced into glycerol and the pressure is increased until 10 vol. % are crushed.

The average diameter is preferably in the range of from 10 μm to 70 μm, more preferably in the range of from 10 μm to 35 μm. The average diameter can be determined using a commercially available laser diffraction particle size analyzer.

The hollow glass spheres preferably have a density of 0.9 g/cm³ or less, more preferably 0.6 g/cm³ or less, and 0.3 g/cm or more. This is the true density of the hollow glass spheres and not the bulk density. The true density of the hollow glass spheres is determined using a pycnometer, such as for example of the AccuPyc II 1340 type from Micromeritics.

Hollow glass spheres that can be used according to the invention are available from 3M. Preferably, hollow glass spheres of the iM16K type are used according to the invention.

In the thermoplastic elastomer composition according to the invention or the thermoplastic elastomer according to the invention, the weight ratio of hollow glass spheres to SBC preferably lies in the range of from 30:100 to 250:100, more preferably in the range of from 50:100 to 150:100.

Component D: Polyolefin or TPC (Non-Functionalized)

The same polyolefins or TPCs as mentioned above for the functionalized polyolefin or functionalized TPC can be used here (but non-functionalized here).

In the thermoplastic elastomer composition according to the invention or the thermoplastic elastomer according to the invention, the weight ratio of polyolefin or TPC (non-functionalized in each case) to SBC preferably lies in the range of from 0:100 to 105:100, more preferably up to 80:100.

It is also preferred that the weight ratio of the sum of polyolefin or TPC (non-functionalized in each case) and functionalized polyolefin or functionalized TPC to SBC lies in the range of from 15:100 to 140:100.

Component E: Plasticizer

Suitable plasticizers are known in principle to a person skilled in the art. Suitable plasticizers for non-polar elastomers (e.g. SBCs) are technical or medicinal mineral or white oils, virgin oils, such as for example soybean or rapeseed oil, and also alkylsulfonyl esters, in particular alkylsulfonylphenyl esters, wherein the alkyl substituents contain linear and/or branched alkyl chains with >5 C atoms; also di- or trialkyl esters of mellitic acid, wherein the alkyl substituents preferably contain linear and/or branched alkyl chains with >4 C atoms. Furthermore, alkyl esters of di-, tri- and higher polycarboxylic acids, wherein the alkyl substituents are preferably linear and/or branched alkyl chains, are also used as corresponding plasticizers. The following may be mentioned as examples: bis(2-ethylhexyl) adipate and tributyl O-acetylcitrate. Furthermore, carboxylic acid esters of mono- and/or polyalkylene glycols, such as for example ethylene glycol adipate, can also be used as plasticizers. According to the invention, technical or medicinal mineral or white oils are preferably used here. Shell Catenex T 145 S may be mentioned as a technical mineral oil.

Mixtures of the described substance classes can also be used as suitable plasticizers.

In the thermoplastic elastomer composition according to the invention or the thermoplastic elastomer according to the invention, the weight ratio of plasticizer to SBC preferably lies in the range of from 50:100 to 300:100, more preferably in the range of from 100:100 to 250:100.

Component F: Additives, Such as Stabilizers, Auxiliary Materials and Colorants

Suitable additives are e.g., but not exclusively, processing aids, metal soaps, fatty acids and fatty acid derivatives, paraffin waxes, microcrystalline waxes, lubricants, mould release agents, flame retardants, smoke suppressants, adhesion promoters, marking substances, minerals, crystallization accelerators and inhibitors, anti-fogging agents, antistatic agents, as well as biocides and fungicides.

The following, for example, can be used as process auxiliaries and stabilizers: anti-ageing agents or antiozonants such as antiozonant waxes, stabilizers such as heat stabilizers, weathering stabilizers; oxidation protection agents, antioxidants, UV stabilizers, other light protection agents, antifoam agents, lubricants, dispersants, release agents, anti-blocking agents, radical scavengers, metal deactivators, and also additives such as foaming aids, propellants, impact modifiers, adhesives and viscosity modifiers.

Furthermore, colorants such as colour masterbatches, pigments, dyes, e.g. titanium dioxide, litophone, zinc oxide, iron oxide, ultramarine blue, chromium oxide, antimony sulfite, can be used as additives.

In the thermoplastic elastomer composition according to the invention or the thermoplastic elastomer according to the invention, the weight ratio of the sum of all the additives to SBC preferably lies in the range of from 0.1:100 to 50:100, more preferably in the range of from 0.5:100 to 25:100.

Production of the Compositions According to the Invention:

The thermoplastic elastomer compositions according to the present invention can be produced by mixing the components A, B, C, D, E and F—if they are present in the compositions. The mixing can be effected using mixing systems that are known in rubber technology and plastics technology, such as kneaders, internal mixers, e.g. internal mixers with intermeshing or tangential rotor geometry, as well as also in continuously mixing systems such as mixing extruders, e.g. mixing extruders with 2 to 4 and more screws (e.g. twin-screw extruders).

While carrying out the production method according to the invention, it is important to make sure that the mixing temperature is high enough that the components B and D—if used according to the invention—can be converted to the plastic state but are not damaged in the process. This is ensured if a temperature above the highest melting or softening point of the components B and D—if used according to the invention—is selected. At the same time, an adequate input of energy must be ensured, which is determined via the speed and throughput in the extruder (see examples).

Particularly preferably, the mixing of the components—if they are present in the compositions—is performed at a temperature in the range of from 150° C. to 240° C., and preferably 180° C. to 220° C.

The terms “comprise”, “contain” and “have” used in the present application are intended also to comprise the term “consist of” in every case in which they are used, with the result that these embodiments are also disclosed in this application.

### EXAMPLES

### Determination Methods and Definitions

The determination of the density is effected according to DIN EN ISO 1183-1.

The determination of the Shore hardness is effected according to DIN EN ISO 868 and DIN ISO 7619-1.

The determination of the tensile strength and elongation at break is 35 effected according to DIN 53504/ISO 37. Deviating from ISO 37, the S2 bar is tested at a rate of advance of 200 mm/min.

The determination of the compression set is effected according to DIN ISO 815-1, method A.

The determination of the tear propagation resistance is effected according to ISO 34-1.

The adhesion of the thermoplastic elastomer compositions to PA6 is determined according to VDI2019; the PA6 used is one with the product name Frianyl B3 V2 NC1102 from Nilit Plastics. The adhesion of the thermoplastic elastomer compositions to polypropylene (PP) (grade: Moplen® HP501L; manufacturer: Basell Polyolefins) is likewise determined according to VDI2019.

The determination of the melt flow index is effected according to DIN EN ISO 1133.

Extruder and Injection-Moulding Parameters:

The production of the thermoplastic elastomers of the present invention is effected in a continuous process on a twin screw extruder (48 L/D). The hollow glass spheres are added via a side feeder. The extruder speed is 500 rpm and the throughput is 20 kg/h. The temperature profile set runs from 170 to 190° C. The extrudate is pelletized for the subsequent processing by injection moulding or extrusion.

The production of the test pieces is effected in an injection moulding process with a temperature profile of from 180 to 200° C.

### Embodiment Examples

Table 1 specifies the abbreviations used for the components used in the examples and comparison examples:

TABLE 1

| Component | Raw material |
|---|---|
| A | SBC |
| B1 | Polyolefin functionalized with an |
| | anhydride of an organic carboxylic acid |
| B2 | Polyolefin functionalized with an |
| | alkoxy- or acyloxysilane |
| C | Hollow glass spheres |
| D | Polyolefin (non-functionalized) |
| E | Plasticizer |
| F | Additives |
| G | Silanized hollow glass spheres |
| H | SBC functionalized with an anhydride of |
| | an organic carboxylic acid |

### Examples and Comparison Examples

Production of Thermoplastic Elastomer Compositions and Elastomers (According to the Invention and not According to the Invention):

Thermoplastic elastomers with the constituents that can be seen from Tables 3 and 4 are produced according to the above-named production variant. Table 2 specifies manufacturers and grades of the components used. The mechanical measurements and values relating to processability are specified in Tables 5 and 6.

TABLE 2

| | Raw materials used | | |
|---|---|---|---|
| Component | Raw material | Manufacturer | Grade |
| A | SBC (non-functionalized) | TSRC | Taipol SEBS 6151 |
| B1 | | BYK | Scona TPPP 2112 GA |
| B2 | Polyolefin (functionalized) | 1) LyondellBasell | 1) Moplen HP501L |
| | | 2) Wacker | 2) Geniosil GF 31 |
| C | Hollow glass spheres (uncoated) | 3M | iM16K |
| D | Polyolefin (non-functionalized) | LyondellBasell | Moplen HP501L |
| E | Plasticizer | Shell | Shell Catenex T 145 S |
| F | Additives: | BASF | Irgafos 168 |
| | Process stabilizer | | |
| G | Hollow glass spheres | Hoffmann Mineral | iM16K ASHM |
| | (functionalized) | | |
| H | SBC (functionalized) | BYK | Scona TSKD 9103* |

*Maleic anhydride grafted SEBS

Production of the Polyolefin B2:

The functionalized polyolefin B2 is produced by grafting the polypropylene Moplen® HP501L with the silane Geniosil® GF 31. To this end, 0.06 wt.-% Peroxan® HXY-85W (85% in white oil) dissolved in 5 wt.-% Geniosil GF 31 is added in liquid form and at room temperature to Moplen® HP501L in a twin screw extruder. The wt.-% data relate to the quantity of polypropylene used. The mixing is effected in the mixing zone while heating slowly, initially to 160° C. The temperature is then increased to 200° C., at which point the free-radical grafting is effected. Volatile constituents are removed by means of vacuum degassing.

TABLE 3
Compositions

| | | Comparison | Comparison | | Comparison | |
|---|---|---|---|---|---|---|
| | | example 1 | example 2 | Example 1 | example 3 | Example 2 |
| Raw material | Component | [proportions | [proportions | [proportions | [proportions | [proportions |
| | | by weight] | by weight] | by weight] | by weight] | by weight] |
| SBC (non- | A | 100 | 100 | 100 | 100 | 100 |
| functionalized) | | | | | | |
| Polyolefin | B1 | | 92 | 92 | 23 | 31 |
| (functionalized) | | | | | | |
| Hollow glass spheres | C | 136 | | 136 | | 115 |
| (uncoated) | | | | | | |
| Polyolefin (non- | D | 92 | | | 9 | |
| functionalized) | | | | | | |
| Plasticizer | E | 200 | 200 | 200 | 200 | 200 |
| Additives: | F | 0.26 | 0.26 | 0.26 | 0.23 | 0.23 |
| process stabilizer | | | | | | |
| Silanized hollow glass | G | | 136 | | 115 | |
| spheres | | | | | | |

Comparison example 1: without interacting groups on polyolefin and hollow glass spheres; Comparison examples 2 and 3: with interacting groups on polyolefin and hollow glass spheres; Examples 1 and 2: with functionalized polyolefin, but uncoated hollow glass spheres

TABLE 4
Compositions

| | | | Comparison | Comparison |
|---|---|---|---|---|
| | | Example 3 | example 4 | example 5 |
| | | [proportions | [proportions | [proportions |
| Raw material | Component | by weight] | by weight] | by weight] |
| SBC (non-functionalized) | A | 100 | 50 | 50 |
| Polyolefin (functionalized) | B1 | | | |
| | B2 | 64 | | |
| Hollow glass spheres (uncoated) | C | 131 | 136 | |
| Polyolefin (non-functionalized) | D | | 92 | 92 |
| Plasticizer | E | 200 | 200 | 200 |
| Additives: | F | 0.25 | 0.26 | 0.26 |
| process stabilizer | | | | |
| Hollow glass spheres (silanized) | G | | | 136 |
| SBC (functionalized) | H | | 50 | 50 |

Example 3: with functionalized polyolefin but uncoated hollow glass spheres;
Comparison example 4: with functionalized SBC but uncoated hollow glass spheres;
Comparison example 5: with non-functionalized polyolefin but uncoated hollow glass spheres

TABLE 5
Mechanical values for the examples from Table 3:
Mechanical values

| | | Comparison | Comparison | | Comparison | |
|---|---|---|---|---|---|---|
| Value | Unit | example 1 | example 2 | Example 1 | example 3 | Example 2 |
| Density | g/cm³ | 0.717 | 0.723 | 0.724 | 0.728 | 0.722 |
| Hardness | ShA | 78 | 87 | 87 | 59 | 61 |
| Tensile strength | MPa | 3 | 5 | 4.9 | 2.9 | 2.9 |
| Elongation at break | % | 587 | 200 | 237 | 293 | 304 |
| Tear propagation | N/mm | 14.5 | 20.7 | 22.1 | 10.9 | 11.6 |
| resistance | | | | | | |
| Compression set at | % | 53 | 35 | 33 | 10 | 13 |
| 23° C./72 h | | | | | | |
| Compression set at | % | 69 | 47 | 42 | 22 | 24 |
| 70° C./24 h | | | | | | |
| Compression set at | % | 81 | 80 | 81 | 71 | 68 |
| 100° C./24 h | | | | | | |
| Melt flow index 230° C./5 kg | cm³/10 min | 112 | 74.5 | 79.5 | 18 .1 | 9.4 |
| Adhesion | N/mm | PP: 3.5 | PA6: 4.2 | | | |

The values for density, hardness, tensile strength, elongation at break and tear propagation resistance were recorded at room temperature.

TABLE 6
Mechanical values for the examples from Table 4:
Mechanical values

| | | | Comparison | Comparison |
|---|---|---|---|---|
| Value | Unit | Example 3 | example 4 | example 5 |
| Density | g/cm³ | 0.728 | 0.747 | 0.724 |
| Hardness | ShA | 78 | 84 | 84 |
| Tensile strength | MPa | 4.1 | 2.6 | 2.8 |
| Elongation at break | % | 245 | 169 | 36 |
| Tear propagation resistance | N/mm | 15.5 | 17.4 | 16.2 |
| Compression set at 23° C./72 h | % | 22 | 58 | 57 |
| Compression set at 70° C./24 h | % | 34 | 88 | 82 |
| Compression set at 100° C./24 h | % | 81 | 96 | 92 |
| Melt flow index 230° C./5 kg | cm³/10 min | 204.2 | 190 | |
| Adhesion | N/mm | PP: 3.8 | | |

The values tor density, hardness, tensile strength, elongation at break and tear propagation resistance were recorded at room temperature.

1. A thermoplastic elastomer composition comprising:
a styrene block copolymer;
a copolyester-based thermoplastic elastomer (TPC) or a polyolefin; and
uncoated hollow glass spheres, wherein the copolyester-based thermoplastic elastomer or the polyolefin is functionalized by a grafting reaction with an anhydride of an unsaturated organic acid or a vinyl alkoxysilane or a vinyl acyloxysilane or a methacryloxyalkyl alkoxysilane or a methacryloxyalkyl acyloxysilane.

2. The thermoplastic elastomer composition according to claim 1, wherein the styrene block copolymer is a triblock copolymer in which two terminal blocks are formed of polystyrene and a central block is formed of a polymer other than polystyrene.

3. The thermoplastic elastomer composition according to claim 2, wherein the central block of the triblock copolymer is formed by a polyolefin.

4. The thermoplastic elastomer composition according to claim 1, wherein the styrene block copolymer is a polystyrene-block-poly(ethylene-co-butylene)-block-polystyrene (SEBS), a polystyrene-block-poly(ethylene-co-propylene)-block-polystyrene (SEPS), a triblock copolymer of polystyrene-polybutadiene-polystyrene (SBS), a polystyrene-block-poly(ethylene-co-(ethylene-propylene))-block-polystyrene (SEEPS), a triblock copolymer of polystyrene-polyisoprene-polystyrene (SIS), a triblock copolymer of polystyrene-polyisobutene-polystyrene (SiBS) or a triblock copolymer of polystyrene-(a mixture of isoprene and butadiene)-polystyrene (SIBS).

5. The thermoplastic elastomer composition according to claim 1, wherein the styrene block copolymer is not grafted with an anhydride of an unsaturated organic acid or a vinyl alkoxysilane or a vinyl acyloxysilane or a methacryloxyalkyl alkoxysilane or a methacryloxyalkyl acyloxysilane.

6. The thermoplastic elastomer composition according to claim 1, wherein the anhydride of an unsaturated organic acid is an anhydride of an organic unsaturated dicarboxylic acid.

7. The thermoplastic elastomer composition according to claim 1, which additionally contains a plasticizer.

8. A method for producing a thermoplastic elastomer, the method comprising:
mixing the constituents of the thermoplastic elastomer composition according to claim 1 together at a temperature in a range of from 150° C. to 240° C.

9. A thermoplastic elastomer, which is obtained by the method according to claim 8.

10. A process for producing the thermoplastic elastomer composition according to claim 1, the process comprising:
providing the polyolefin or the TPC, wherein the polyolefin or the TPC is functionalized with an anhydride of an organic carboxylic acid or a vinyl alkoxysilane or a vinyl acyloxysilane or a methacryloxyalkyl alkoxysilane or a methacryloxyalkyl acyloxysilane.

11. A process for producing a thermoplastic elastomer composition according to claim 1, the process comprising:
providing uncoated hollow glass spheres.

12. A process for producing a composite material with a thermoplastic, the process comprising:
providing the thermoplastic elastomer according to claim 9.

13. A composite material composed of a thermoplastic elastomer according to claim 9 and a thermoplastic.

14. A process for producing a component or shaped body in an automotive interior and exterior sector, industrial equipment, industrial tools, electrical tools for professional and/or private use, domestic appliances, products in the consumer electronics sector, medical consumables and devices, sports equipment, containers for toiletries and cosmetics, sealing materials or preparations of consumer products, the process comprising:
selecting the thermoplastic elastomer according to claim 9.

15. The method according to claim 6, wherein the anhydride of an organic unsaturated dicarboxylic acid is an organic unsaturated 1,2-dicarboxylic acid.
